(19) United States
(12) Patent Application Publication
(10) Pub. No.: US 2002/0078442 A1
(43) Pub. Date: Jun. 20, 2002

(54) System and method for securing programming or channel information

(76) Inventors: Ana Reyes, San Diego, CA (US); Hong Yang, San Diego, CA (US); Jenny Su Chow, San Diego, CA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 09/745,607

(22) Filed: Dec. 20, 2000

(51) Int. Cl. H04N 7/16; G06F 3/00; H04N 5/445; G06F 13/00

(52) U.S. Cl. 725/25; 725/30; 725/37

(57) ABSTRACT

The present invention relates to an entertainment system and method for controlling the transmission of control information to an input device in an entertainment system. The system receives programming data associated with a broadcast channel and displays a show associated with the channel. The input device is then configured to operate in a first mode that suspends transmission of input control information entered via said input device, to the entertainment system. Various embodiments are described.

### BACKGROUND OF THE INVENTION

1. Field of the Invention

The present invention relates generally to the presentation of channel, program, and broadcast information for a multiple channel television broadcast system. More particularly, the present invention relates to a system and method for securing a channel or program in a broadcast system.

2. Description of Art Related to the Invention

In recent years, there has been a increasing demand for entertainment systems working in conjunction with various types of broadcasting systems, including systems that broadcast on the airwaves, through cable and via satellite. Along with this demand is a corresponding increase in the number of stations accessible. To select a program to view, many viewers simply “channel surf” until they find a channel with a desirable program. Channel surfing refers to the process of sequentially viewing each channel.

Although some viewers find channel surfing among hundreds of stations enjoyable, many viewers prefer to limit the viewing of certain channels by minors. In addition, most viewers prefer to prevent accidental redirection of a viewing channel by children or other adults.

### SUMMARY OF THE INVENTION

The present invention relates to an entertainment system and method for controlling the transmission of control information to an input device in an entertainment system. The system receives programming data associated with a broadcast channel and displays a show associated with the channel. The input device is then configured to operate in a first mode that suspends transmission of input control information entered via said input device, to the entertainment system. Various embodiments are described.

### BRIEF DESCRIPTION OF THE DRAWINGS

FIG. 1A is an illustrative embodiment of an entertainment system utilizing the present invention.

FIG. 1B is an illustrative embodiment of the remote control 115 of FIG. 1A.

FIG. 2A illustrates one embodiment of a view screen with an options menu 200 provided in accordance with the principles of the invention.

FIG. 2B illustrates one embodiment of a view screen with the Locks and Limits menu 210₃ provided in accordance with the principles of the invention.

FIG. 2C illustrates one embodiment of a window superimposed over the Locks and Limits menu 210₃ provided in accordance with the principles of the invention.

FIG. 3A illustrates one embodiment of a process for locking a remote control in accordance with the principles of the invention.

FIG. 3B illustrates one embodiment of a process for unlocking a remote control in accordance with the principles of the invention.

FIG. 3C illustrates one embodiment of a process for confirming that the remote control is locked.

FIG. 3D is a flow chart illustrating one embodiment of a process for unlocking the remote control.

FIG. 3E illustrates one embodiment of a process for confirming that the remote control is unlocked.

FIG. 4 illustrates a detailed block diagram of one embodiment of the IRD 110 of FIG. 1A.

FIG. 5 illustrates a detailed block diagram of one embodiment of the Main Logic Block 410 of FIG. 4.

### DESCRIPTION OF THE PREFERRED EMBODIMENT

In one embodiment, the present invention relates to a system and method for locking and unlocking the control functions of a remote control that is used in a broadcast system. The system enables the user to configure an input device such as a remote control to suspend transmission of control information entered via the remote control, to the entertainment system. Such transmission of control information may be reactivated by selecting and depressing a dedicated key on the remote control.

Herein, various terms are used to describe certain elements or characteristics of the present invention. For example, a “communication link” is broadly defined as any communication path between a source and a destination. The communication line may include one or more information-carrying lines (electrical wire, fiber optics, cable, etc.) or wireless communications through established techniques such as infrared (IR) and radio frequency (RF) signaling. A “signal” is construed as information transmitted in a parallel or serial manner. Stored within the system, “programming data” includes information of channels chosen by the user to be entered into memory. While certain illustrative embodiments are described in order to convey the spirit and scope of the present invention, such embodiments should not be construed as a limitation on the scope of the present invention.

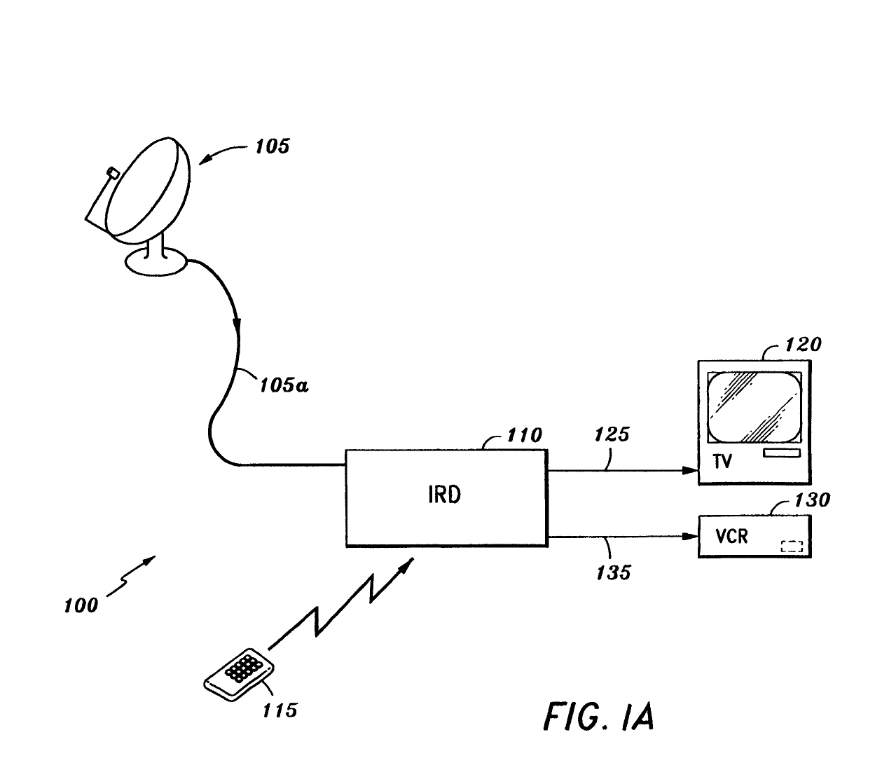

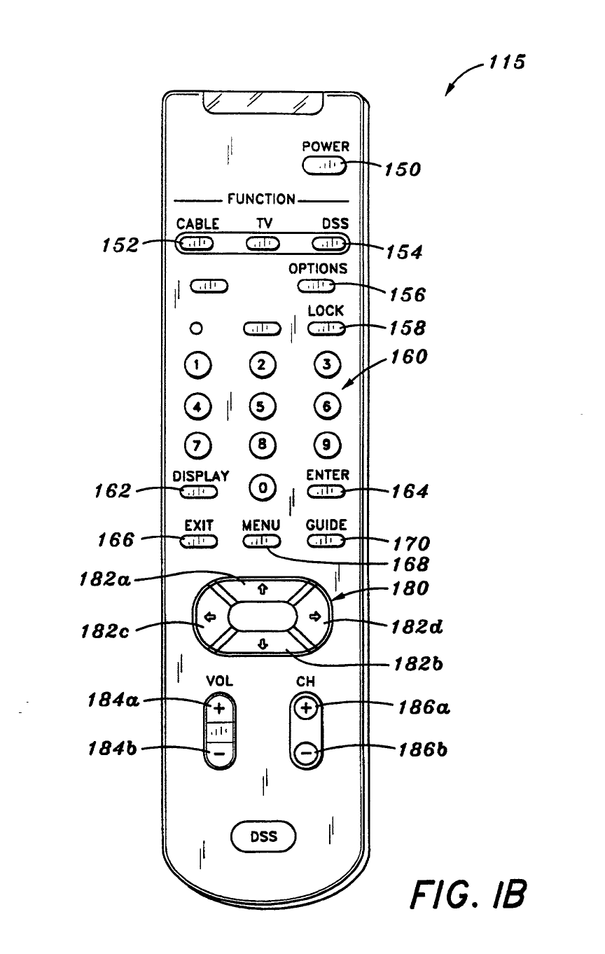

Referring to FIG. 1, one embodiment of an entertainment system utilizing the present invention is shown. The entertainment system 100 comprises an antenna 105, a broadcast receiver 110 such as an integrated receiver decoder (IRD) for example, and at least one analog-input peripheral device (e.g., a display monitor such as television receiver “TV” 120 and/or an analog recording device 130 such as a video cassette recorder “VCR”). The broadcast receiver, in general, receives a broadcast signal (a digital bit stream for example) and performs operations on the broadcast signal to produce digital and/or analog information. Although the IRD is implemented as the broadcast receiver in this embodiment, other types of broadcast receivers may be used such as a cable box for a Cable Broadcasting System, an Internet terminal, a digital satellite system (DSS) computer and the like.

Antenna 105 receives the digital bit stream from an orbiting satellite (not shown) and routes the bit stream to IRD 110. The bit stream is formatted in accordance with any video compression function and is usually encrypted under either a symmetric key cryptographic function or a public-key cryptographic function. Typically, the bit stream includes sensory data (e.g., video and/or audio, or communication data) and control information for a number of shows. The control information for each show includes programming data having the following content: date of broadcast, broadcast channel number, show start-time, show end-time, and also show title.

IRD 110 is responsible for decoding the bit stream, for storing programming data in timer memory accessible by software executed by IRD 110, and for processing the decoded bit stream to produce one or more output signals having appropriate formats. As shown, an output signal is placed in an analog format and sent via communication line 125 to TV 120 for viewing, and/or via communication line 135 to analog recording device 130 for recording. The analog format may be in accordance with a video format established by National Television Systems Committee (NTSC), or perhaps other video formats, including but is not limited or restricted to Phase Alternating Line (PAL), Sequential Couleur Avec Memoire (SECAM) and other recognized formats.

Additionally, IRD 110 is responsible for responding to a plurality of commands from a remote control 115. Remote control 115 may include any type of remote control, including one described in U.S. Pat. No. 5,453,758 assigned to Sony Corporation of Tokyo, Japan. FIG. 1B is an illustrative embodiment of the remote control 115 of FIG. 1A. The remote control 115 comprises a power key 150 for activating the IRD 110 via a communication link, a cable key 152 which facilitates selection of cable channels, a DSS key 154 which facilitates selection of satellite-based channels, an OPTIONS key 156 for facilitating selection of desired channels; a LOCK key 158 for facilitating locking and unlocking of the control functions of the remote control 115, a numerical keypad 160, a DISPLAY key 162, an ENTER key 164, an EXIT key 166, a MENU key 168, and a GUIDE key 170. The remote control 115 further comprises an ABXY button grid 180 (which includes scroll buttons 182a-d), a pair of volume keys 184a, 184b, and a pair of channel selection keys 186a, 186b. In one embodiment, the ABXY button grid 180 is a video game control used by many commercially available video systems such as those made and manufactured by Nintendo of Japan.

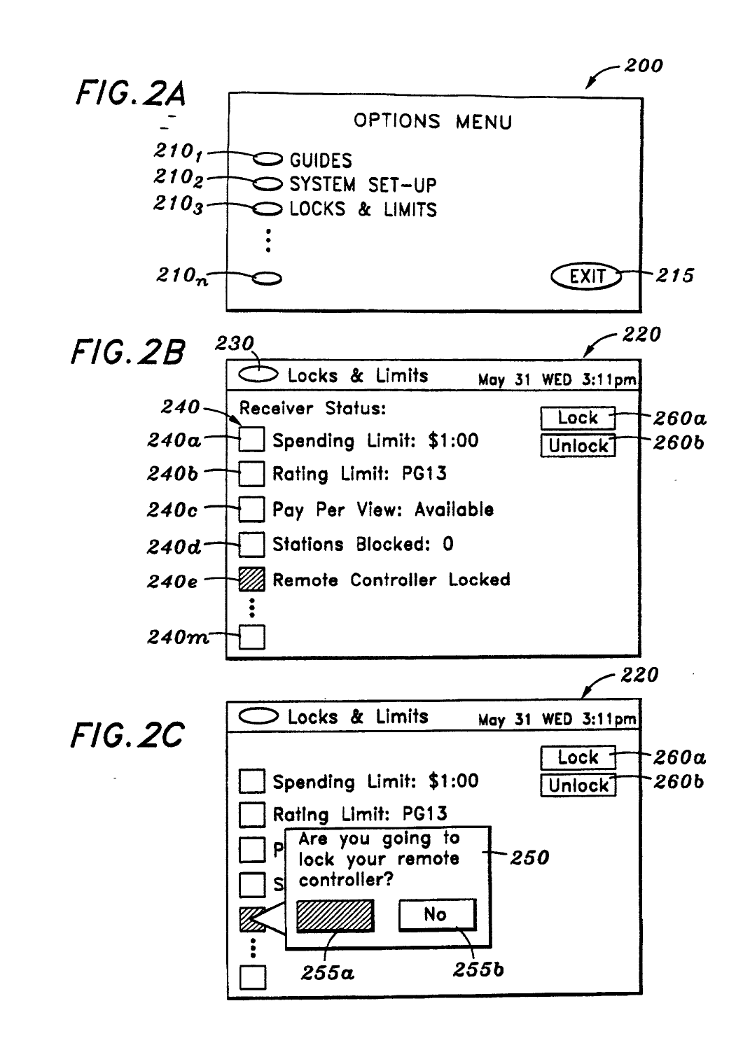

Prior to using the locking and unlocking features provided in accordance with the principles of the invention, the remote control 115 has to be set up for such use. To accomplish this, the user may issue a first command from the remote control 115 by pressing the OPTIONS key 156, causing IRD 110 to produce an output signal displaying an options menu 210 on TV 120, as shown in FIG. 2A. The options menu 210 may be superimposed over a view screen 200 displaying a show from a selected channel. In one embodiment, the options menu 210 comprises a number of icons 210₁-210ₙ, each of which can be selected to perform a function associated with the system. In one embodiment, the options menu 210 includes a GUIDES icon 210₁ that the user may select to review additional menus or guide screens, a System Set up icon 210₂, that the user may select to view or adjust the system controls, a Locks and Limits icon 210₃, that the user may select to view the status of the receiver, such as IRD 110. The options menu 210 may also include further icons, which may be selected by using the ABXY button grid 180 (which includes scroll buttons 182a-d), followed by the ENTER key 164. Alternatively, the viewer may scroll through the list using the channel buttons 186a, 186b. To exit from the options menu 200, the viewer may select the EXIT icon 215.

FIG. 2B illustrates one embodiment of the Locks and Limits view screen 220 that is displayed upon selection of the Locks and Limits icon 210₃. The Locks and Limits view screen 220 includes a banner portion 230 having indicia representative of the view screen that was selected for viewing, which in this case is the Locks & Limits, and a body portion 240 that includes a plurality of icons 240₁-240ₘ that may be selected to activate or deactivate various functions of the receiver. In one embodiment, the icon 240e may be selected to lock or unlock the Remote Control 115. Such selection may be accomplished by using the ABXY button grid 180 (which includes scroll buttons 182a-d), followed by the ENTER key 164. Upon selection of the Remote Control Lock icon 240e, a window 250 (see FIG. 2C) pops up, to query if the user would like to lock his or her remote control. The window 250 includes a YES icon 255a and a NO icon 255b, which may be selected using the ABXY button grid 180 to scroll down the list, followed by selection using the ENTER key 164. Alternatively, the viewer may scroll through the list using the channel buttons 186a, 186b. If the YES icon 255 is selected, a LOCK icon 260a is highlighted, indicating that this feature is activated. Conversely, if the NO icon 255b is selected, an UNLOCK icon 260b is highlighted, indicating that the Remote Control Lock feature is not activated. Once the remote control 115 is set up using the Locks and Limits view screen 220, the Remote Control Locking feature may be used.

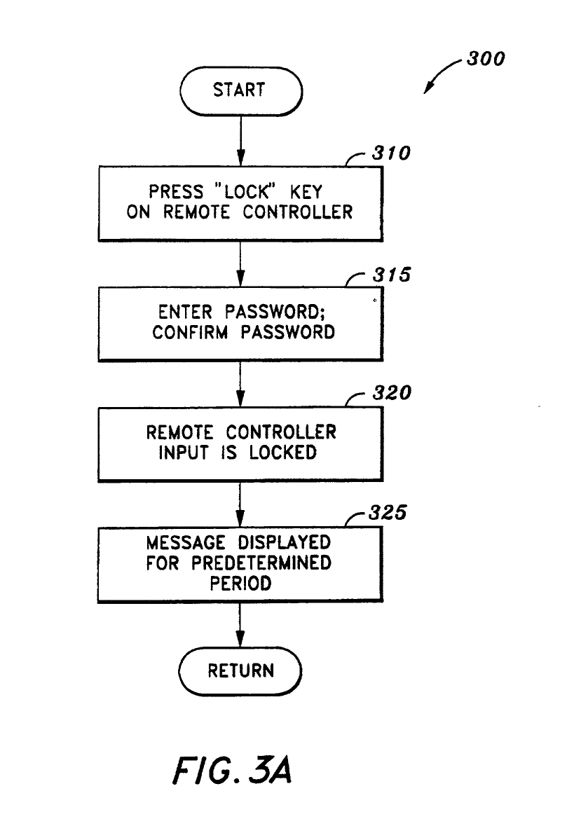

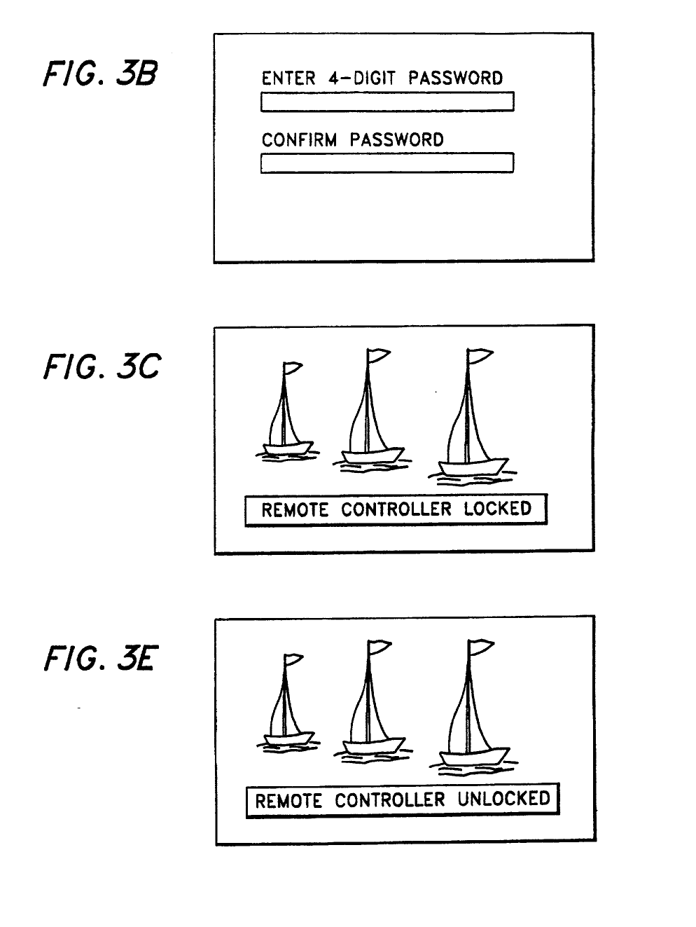

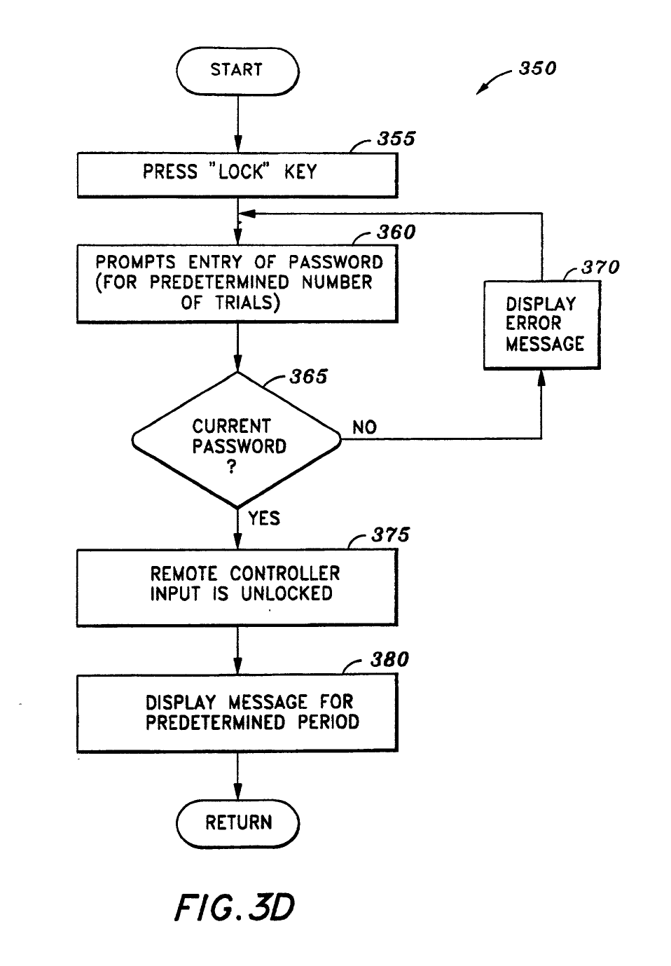

FIG. 3A illustrates one embodiment of a process for locking a remote control in accordance with the principles of the invention. To accomplish this, the viewer may issue a command via remote control 115 by pressing the LOCK key 158 (process block 310), causing IRD 110 to produce an output signal displaying a password menu on TV 120. The password menu prompts the user to enter a password (such as a 4-digit password), followed by a prompt to confirm the previously entered password by reentering the same password (process block 315; see FIG. 3B). If the two passwords match, inputs to the remote control 115 are locked, i.e., inactivated, with the exception of the POWER key 150 and the OPTIONS key 156 (process block 320). A message, “Remote Control Locked” is displayed on the screen (see FIG. 3C) for a predetermined period, such as 5 seconds. The process then terminates or returns to a main process.

FIG. 3D illustrates one embodiment of a process 350 for unlocking a remote control in accordance with the principles of the invention. To unlock the remote control 115, the user may press the LOCK key 164 (process block 355). In response, the receiver, such as IRD 115 prompts the user to enter the password (process block 360) by displaying a message on the display screen of TV 120. Upon entry of the password, the IRD 115 determines if the entered password matches the password previously entered by the user (process block 365). If not, the process 350 displays an error message (process block 370) and returns to process block 360, where it prompts the user to enter the password again. This process 360 may be repeated for a predetermined number of times before it is terminated due to the entry of an invalid password. If a correct or valid password is entered, the process 350 proceeds to process block 375, where the remote control input is unlocked or reactivated. The process 350 then displays a message indicating that the remote control is unlocked, as shown in process block 380 and FIG. 3E, before terminating.

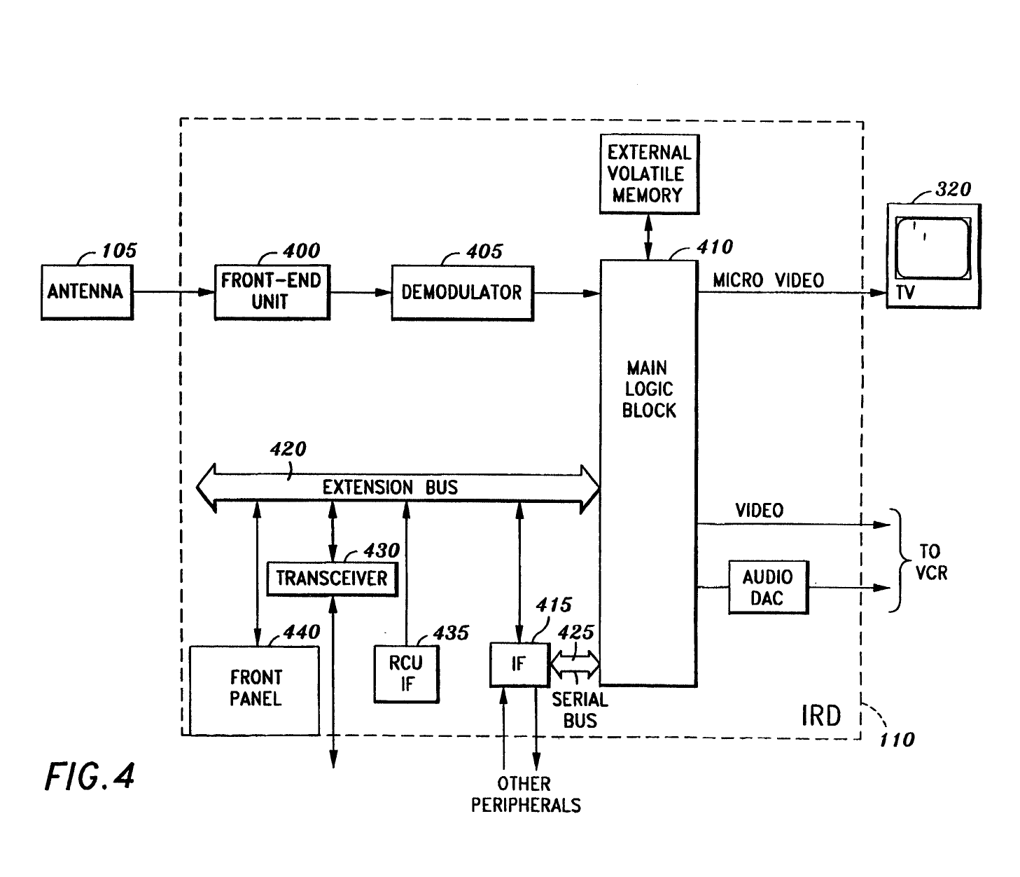

Referring now to FIG. 4, one embodiment of an integrated receiver decoder (IRD) 110 is shown. The antenna 105 transfers the bit stream to a front-end unit 400 of the IRD 110. Although not shown, the front-end unit 400 includes (i) amplification circuitry used to amplify any relatively weak signals received at antenna 105, and (ii) a tuner which allows a user to receive a desired broadcast channel.

For the case where the user wishes to view a show provided by the digital satellite system service provider, the bit stream associated with the desired broadcast channel is routed from front-end unit 400 to a demodulator 405. In demodulator 405, the bit stream is initially processed before transferring to a main logic block 410 for further processing. Such initial processing may include exposing the bit stream to QPSK-demodulation, viterbi-decoding, de-interleaving and Reed-Solomon decoding.

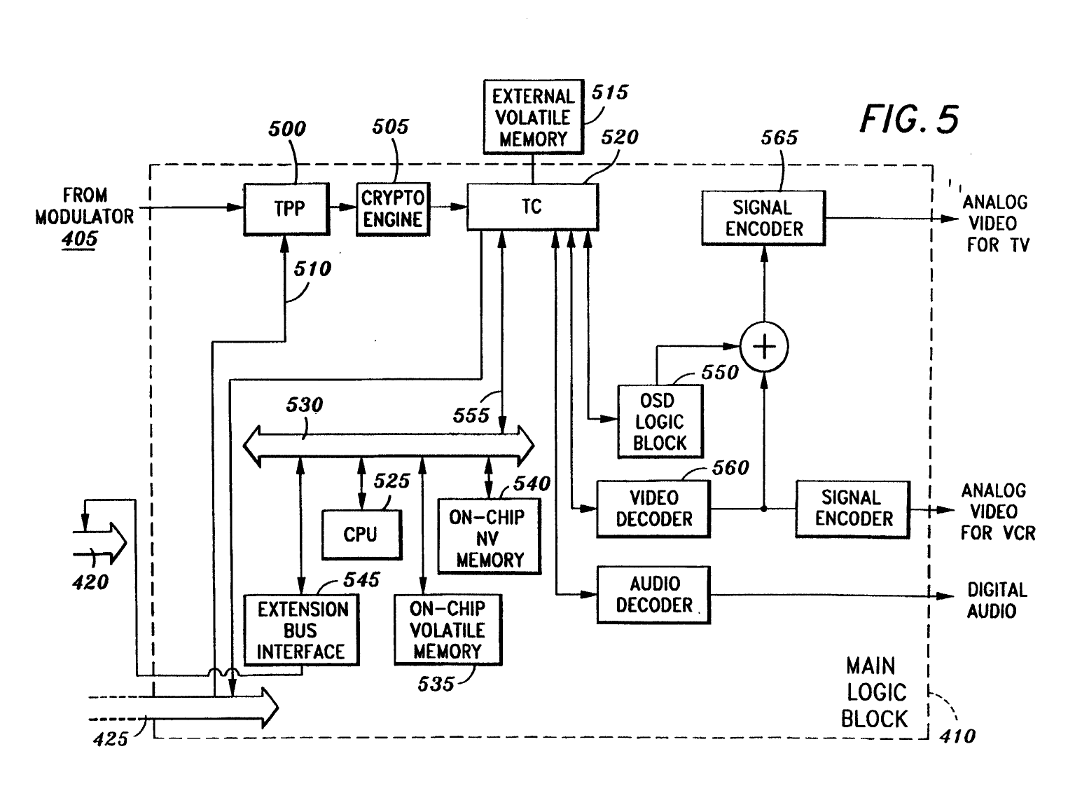

In certain situations, IRD 110 is connected to other peripheral devices though an interface (IF) 415. In this embodiment, IF 415 may include a link layer integrated circuit (IC) and a physical layer IC (not shown) and complies with the IEEE standards document 1394 entitled “Standard for High Performance Serial Bus” (hereinafter referred to as “IEEE 1394”). This enables IRD 110 to connect to digital-input peripheral devices such as digital VCRs, digital video disk players, digital laser disk players and the like. These digital-input peripheral devices communicate with a central processing unit (CPU) within main logic block 410 (see FIG. 5) through IF 415 and either extension bus 420 or alternatively an IEEE 1394 serial bus 425.

Referring still to FIG. 4, extension bus 420 supports input/output (I/O) communications by providing a communication path between electronic circuitry of the main logic block 410 and a number I/O related devices. These I/O related devices include a transceiver device 430 (e.g., a modem), a remote command unit interface (RCU-IF) 435, and a front panel 440. In one embodiment, the front panel 440 includes buttons or switches for receiving user input or commands. The buttons or switches may correspond to those on the remote control 115 and the buttons or switches on the front panel 440 may be used to issue commands to the IRD 110 instead of the remote control 115. RCU-IF 435 receives commands from the remote control 115, and decodes the commands to produce interrupt request signals (IRQs) corresponding to these commands. Each IRQ is transferred to the CPU within the main logic block 410. The front panel 440 includes buttons or switches to provide user functionality and access to the system as described herein. Control of such user functionality and access may also be provided through use of the keys in remote control 115 as described earlier.

Referring now to FIG. 5, electronic circuitry of the main logic block 410 is shown. The Transport Packet Parser (TPP) 500 receives the decoded bit stream and parses the bit stream. This parsed bit stream is decrypted by a cryptographic engine 505 which may operate in accordance with a cryptographic function, for example Data Encryption Standard (DES). However, if the bit stream is received from IF 415 via communication line 510, cryptographic engine 505 will be precluded from decrypting the bit stream since it is already in a decrypted form. Thereafter, the decrypted bit stream, including the programming data, is stored in an external volatile memory 515 (e.g., random access memory “RAM”) under the control of traffic control (TC) 520.

CPU 525 controls the operations of the IRD by communicating with a plurality of elements through an internal high-speed bus 530. These elements include an optional volatile memory 535, at least one non-volatile (NV) memory element 540 (e.g., read only memory “ROM”, erasable programmable read only memory “EPROM”, flash memory, etc.) to contain software programs, extension bus interface 545, and traffic control 520. NV memory element 540, in lieu of external NV memory 445 of FIG. 4, may be used to store software needed by CPU 525 (e.g., interrupt software) or perhaps stored channel data. Extension bus interface 545 allows CPU 525 to communicate with the devices coupled to extension bus 420.

Referring to FIGS. 4-5, the operations performed by IRD 110 to support remote control function locking and unlocking is described. Upon receiving the first command from the remote control (e.g., user depressing “OPTIONS” button of remote control), RCU-IF 435 transfers a first interrupt request signal (IRQ1), corresponding to the first command, directly to CPU 525 or indirectly through a queuing mechanism (not shown). In response to detecting IRQ1, CPU 525 executes interrupt software contained in external NV memory element 445 (or NV memory element 540) and services IRQ1.

More specifically, in order to service IRQ1, CPU 525 executes interrupt software, normally coded to control an on-screen display (OSD) logic block 550, to produce the options menu 200 (see FIG. 2A). The user may then use the ABXY grid or the channel buttons 186a, 186b to scroll through the icons 210₁-210ₙ. Selection of any one of the icons may be accomplished by pressing the ENTER key 164. Upon selecting the LOCKS & LIMITS icon 210₃, the LOCKS & LIMITS view screen 220 is displayed. The user may scroll through the icons 240ₐ₋ₘ using the ABXY grid or the channel buttons 186a, 186b. To select locking of the remote control 115, the user may scroll to icon 240e and press the ENTER key 164 (see FIG. 2B). In response, a prompt window 250 appears, inquiring if the user would like to implement the remote control lock feature. If the user selects the YES icon 255a in window 250, the icon LOCK 260a on the LOCKS & LIMITS view screen 220 will light up, indicating that the remote control lock feature has been activated.

The user can now user the remote control lock feature. To do so, he has to press the LOCK key 158 on the remote control 115. Upon receiving this command from the remote control, RCU-IF 435 transfers a second interrupt request signal (IRQ2), corresponding to the second command, directly to CPU 525 or indirectly through a queuing mechanism (not shown). In response to detecting IRQ2, CPU 525 executes interrupt software contained in external NV memory element 445 (or NV memory element 540) and services IRQ2. In one embodiment, the CPU 525 signals traffic control 520, via communication line 555, to retrieve at least programming data contained in external volatile memory 515 and route the programming data to OSD logic block 550. Next, CPU 525 controls OSD logic block 550 to decompress the programming data in accordance with a recognized video format and to produce (for display) a password display window in a manner well-known in the art. In general, the programming data is processed as a bitmap to overlay appropriate grids forming the layout of the password display window. The user may enter a password into the field provided in the password display window and confirm the password by entering a second time. Thereafter, inputs to the remote control 115 are locked. In one embodiment, a message is briefly displayed on the display screen of TV 120 to indicate that inputs to the remote control 115 are locked.

As discussed previously, the remote control locking feature may be deactivated by pressing the LOCK key 158, which is received by RCU-IF 435. In response, RCU-IF 435 transfers a third interrupt request signal (IRQ3), corresponding to the command, directly to CPU 525 or indirectly through a queuing mechanism (not shown). In response to detecting IRQ3, CPU 525 executes interrupt software contained in external NV memory element 445 (or NV memory element 540) and services IRQ3 by displaying a password display window. When a matching password is entered, the remote control locking feature is deactivated. In one embodiment, a message is briefly displayed on the display screen of TV 120, indicating that the remote control is unlocked.

The options menu 200, LOCKS & LIMITS display screen 220, and/or the password display screen may be superimposed over video by mixing the options menu 200, LOCKS & LIMITS display screen 220 and/or the password display screen with video output from video decoder 560. The video output is video received by main logic block 410 and decompressed in accordance with Moving Picture Experts Group (MPEG), Joint Picture Experts Group (JPEG) or any other video decompression function. The resulting mixed video output is transferred to signal encoder 565. Signal encoder 565 converts the mixed video output into an analog signal having a recognized video format such as NTSC, PAL, SECAM and the like.

In one embodiment, to scroll through the list of icons, the viewer may be use the scroll buttons 382a-d on the ABXY button grid 380 of the remote control 115. For example, the central processing unit 525 (FIG. 5) may be configured to execute software (stored in either NV memory 445 or NV memory 540) so as to scroll through the index 380, e.g., from the bottom to the top, by depressing the up scroll button 182a or from the top to the bottom, by depressing the down scroll button 182b. Similarly, the central processing unit 525 may be configured to execute software so as to scroll through the index 380 from right to left, by depressing the left scroll button 182c or to scroll through the index 380 from left to right, by depressing the right scroll button 182d. Each time a scroll button 182a, b, c or d is depressed, the corresponding channel is displayed. As discussed earlier, the viewer may select to view a highlighted channel in guide 380 by depressing the + channel key 186a, in accordance with the instructions provided in the channel selection guide 362.

It is contemplated that the invention may be implemented for use in display systems other than that provided using an IRD 110. For example, the invention may be implemented in a television system, an in-flight entertainment system, or a computer network system or any other electronic system.

Through the implementation of the present invention, inputs to a remote control may be blocked or locked, and vice versa, so that control inputs to a target device, such as a television, or an IRD, will be suspended. As a result, viewing interruption of a selected show or channel is minimized.

The present invention described herein may be designed in many different embodiments and using many different configurations. As discussed herein, the architecture of the IRD is flexible. While the present invention has been described in terms of various embodiments, other embodiments may come to mind to those skilled in the art without departing from the spirit and scope of the present invention. The invention should, therefore, be measured in terms of the claims which follow.

What is claimed is:

1. A method for controlling the transmission of control information to an input device in an entertainment system, comprising:
receiving programming data associated with a broadcast channel
displaying a show associated with the channel;
configuring an input device to operate in a first mode that suspends transmission of input control information entered via said input device, to the entertainment system.

2. The method of claim 1, further comprising displaying a message indicating that said input device is configured to operate in the first mode.

3. The method of claim 2, wherein said message is displayed for a predetermined period of time.

4. The method of claim 1, wherein configuring the input device comprises:
selecting a key on said input device;
prompting the user to enter a password;
displaying a menu having at least one option that facilitates configuration of said input device to operate in said first mode that suspends transmission of input control information to the entertainment system;
selecting said at least one option.

5. The method of claim 4, further comprising displaying a status key indicating that said first mode is selected.

6. The method of claim 1, further comprising receiving an instruction to configure the input device to operate in a second mode that facilitates unlimited transmission of input control information to the entertainment system.

7. The method of claim 6, wherein receiving said instruction to configure the input device to operate in the second mode comprises:
selecting said key on said input device;
prompting the user to enter the password;
confirming the validity of said password;
displaying a menu having an option that facilitates configuration of said input device to operate in said second mode that facilitates unlimited transmission of input control information to the entertainment system;
selecting said option that facilitates configuration of said input device to operate in said second mode.

8. The method of claim 7, further comprising displaying a message indicating that said input device is configured to operate in the second mode.

9. The method of claim 1, further comprising terminating transmission of all input control information to said entertainment system entered via said input device.

10. The method of claim 9, further comprising reactivating transmission of all input control information to said entertainment system entered via said input device upon selection of a dedicated key on said input device.

11. An entertainment system comprising:
a display monitor; and
a broadcast receiver coupled to the display monitor, the broadcast receiver including
a front-end unit capable of receiving programming data associated with a show broadcast for viewing on the display monitor,
a memory, and
a central processing unit coupled to the memory, the central processing unit coupled to receive programming data associated with a broadcast channel, the central processing unit to execute software to display a show associated with the channel, said central processing unit to execute software to configure an input device to operate in a first mode that suspends transmission of input control information entered via said input device, to the entertainment system.

12. The entertainment system of claim 11, wherein the central processing unit further executes software to display a message indicating that said input device is configured to operate in the first mode.

13. The entertainment system of claim 12, wherein said message is displayed for a predetermined period of time.

14. The entertainment system of claim 11, wherein configuring the input device comprises:
selecting a key on said input device;
prompting the user to enter a password;
displaying a menu having at least one option that facilitates configuration of said input device to operate in said first mode that suspends transmission of input control information to the entertainment system;
selecting said at least one option.

15. The entertainment system of claim 14, wherein said central processing unit further executes software to display a status key indicating that said first mode is selected.

16. The entertainment system of claim 11, wherein said central processing unit further receives an instruction to configure the input device to operate in a second mode that facilitates unlimited transmission of input control information to the entertainment system.

17. The entertainment system of claim 16, wherein receiving said instruction to configure the input device to operate in the second mode comprises:
selecting said key on said input device;
prompting the user to enter the password;
confirming the validity of said password;
displaying a menu having an option that facilitates configuration of said input device to operate in said second mode that facilitates unlimited transmission of input control information to the entertainment system;
selecting said option that facilitates configuration of said input device to operate in said second mode.

18. The entertainment system of claim 17, wherein said central processing unit further displays a message indicating that said input device is configured to operate in the second mode.

19. The entertainment system of claim 11, wherein transmission of all input control information to said entertainment system entered via said input device is terminated.

20. The entertainment system of claim 19, wherein transmission of all input control information to said entertainment system entered via said input device is reactivated, upon selection of a dedicated key on said input device.
